(19) United States
(12) Patent Application Publication
(10) Pub. No.: US 2013/0067535 A1
(43) Pub. Date: Mar. 14, 2013

(54) APPARATUS AND METHOD FOR CONTROLLING A NETWORK CONNECTION

(71) Applicants: Young Jun KANG, Seoul (KR); Tae Nyun KIM, Seoul (KR); Hoon Min PARK, Seoul (KR)

(72) Inventors: Young Jun KANG, Seoul (KR); Tae Nyun KIM, Seoul (KR); Hoon Min PARK, Seoul (KR)

(73) Assignee: PANTECH CO., LTD., Seoul (KR)

(21) Appl. No.: 13/463,485

(22) Filed: May 3, 2012

(30) Foreign Application Priority Data
Sep. 8, 2011 (KR) 10-2011-0091365

(51) Int. Cl. G06F 21/20

(52) U.S. Cl. 726/3

(57) ABSTRACT

An apparatus and method for controlling access to a network in portable terminal based on a characteristic of an application may determine the characteristic of the application based on at least one of a reference security level of the application, a reference data amount of the application, and a reference speed of the application, and may select a network to be connected to from among available networks based on the characteristic of the application when executing the application.

### CROSS-REFERENCE TO RELATED APPLICATION

This application claims priority from and the benefit of Korean Patent Application No. 10-2011-0091365, filed on Sep. 8, 2011, which is hereby incorporated by reference for all purposes as if fully set forth herein.

### BACKGROUND

1. Field

Exemplary embodiments of the present disclosure relate to a network control apparatus and method for controlling a network connection, and in particular, an apparatus and method for determining a characteristic of an application in a portable terminal, which may connect the application with a suitable network based on the characteristic of the application.

2. Discussion of the Background

In general, if connecting a device to a network, a suitable network may be selected based on a signal strength of each network, an amount of battery consumed by each network, network overload, and interference to access the network.

In the case of the above network selection method, it may be difficult to select a suitable network with respect to an application that has a different security level for each network and may generate a greater amount of data traffic.

In a recent hacking test of a wireless fidelity (Wi-Fi) network, nearly all of information transmitted and received between users was determined to have been leaked by the Wi-Fi network. Due to distribution of portable terminals such as smart phones, uses of applications vulnerable to security breaches, for example, mobile Internet banking, a security application, and the like, have been increasing. Accordingly, a selection of a network may be based on more than a signal strength of each network, an amount of battery consumed by each network, network overload, and interference between accesses.

### SUMMARY

Exemplary embodiments of the present invention provide an apparatus and method for controlling a network connection.

Exemplary embodiments of the present invention also provide an apparatus and method for determining a characteristic of an application.

Additional features of the invention will be set forth in the description which follows, and in part will be apparent from the description, or may be learned by practice of the invention.

An exemplary embodiment of the present invention discloses an apparatus to is control access to a network, including: a characteristic determining unit to determine an application characteristic; a communication unit to determine if networks are available to connect to, and to connect to a first network; a network control unit to select the first network according to the application characteristic, and wherein the application characteristic is based on at least one of a reference security level of the application, a reference data volume of the application, and a reference speed of the application.

An exemplary embodiment of the present invention also discloses a method for controlling access to a network, including: determining if networks are available at a location; determining an application characteristic; selecting a first network to connect to according to the application characteristic; and connecting to the first network, wherein the application characteristic is based on at least one of a reference security level of the application, a reference data volume of the application, and a reference speed of the application.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram illustrating a portable terminal according to an exemplary embodiment of the present invention.

FIG. 2 is a flowchart illustrating a method for determining a characteristic of an application according to an exemplary embodiment of the present invention.

FIG. 3 is a flowchart illustrating a method for connecting to a network according to an exemplary embodiment of the present invention.

FIG. 4 is a flowchart illustrating a method for selecting a network to be connected to according to an exemplary embodiment of the present invention.

FIG. 5 is a flowchart illustrating a method for selecting a network to be connected to according to an exemplary embodiment of the present invention.

FIG. 6 is a diagram illustrating a characteristic database according to an exemplary embodiment of the present invention.

FIG. 7 is a diagram illustrating a characteristic database according to an exemplary embodiment of the present invention.

FIG. 8 is a diagram illustrating a user pattern database according to an exemplary embodiment of the present invention.

FIG. 9 is a diagram illustrating a shared characteristic database according to an exemplary embodiment of the present invention.

FIG. 10A is a screenshot illustrating classifying and outputting an application according to an exemplary embodiment of the present invention.

FIG. 10B is a screenshot illustrating classifying and outputting an application according to an exemplary embodiment of the present invention.

FIG. 11A is a screenshot illustrating displaying a characteristic of an application on an icon according to an exemplary embodiment of the present invention.

FIG. 11B is a screenshot illustrating displaying a characteristic of an application is on an icon according to an exemplary embodiment of the present invention.

FIG. 11C is a screenshot illustrating displaying a characteristic of an application on an icon according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element is referred to as being “connected to” another element, it can be directly connected to the other element, or intervening elements may be present. In contrast, when an element or layer is referred to as being “directly connected to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

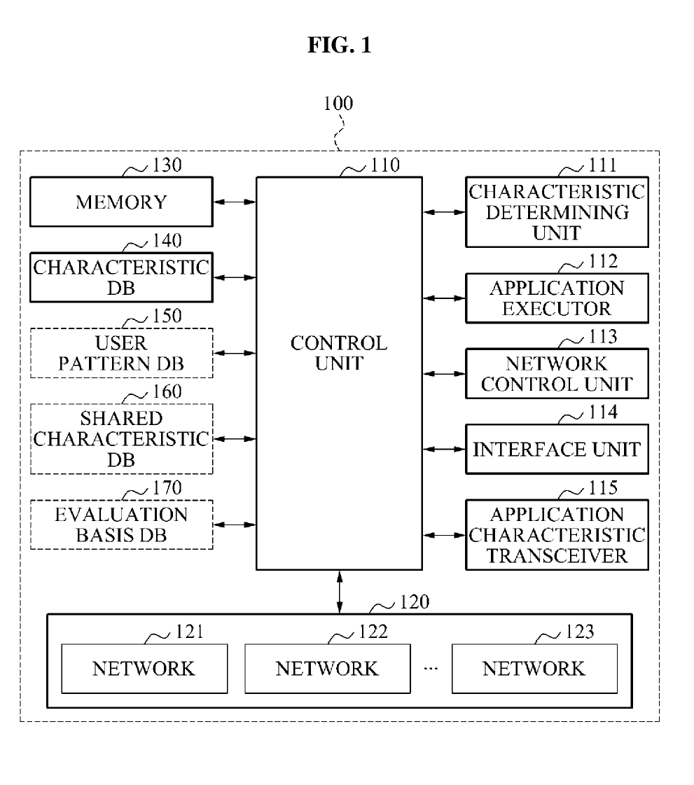

FIG. 1 is a block diagram illustrating a portable terminal according to an exemplary embodiment of the present invention.

Referring to FIG. 1, the portable terminal 100 may include a control unit 110, a characteristic determining unit 111, an application executor 112, a network control unit 113, an is interface unit 114, an application characteristic transceiver 115, a communication unit 120, a memory 130, and a characteristic database (“DB”) 140. The portable terminal 100 may further include a user pattern DB 150, a shared characteristic DB 160, and an evaluation basis DB 170.

The communication unit 120 may connect the portable terminal 100 to one or more of a plurality of networks, for example, network 121, network 122, and network 123. The network 121, the network 122, and the network 123 may transmit and receive data wirelessly using a wireless communication scheme based on a frequency division multiple access (FDMA), a time division multiple access (TDMA), a space division multiple access (SDMA), a code division multiple access (CDMA), a wideband code division multiple access (WCDMA), an orthogonal frequency division multiplexing (OFDM), wireless fidelity (Wi-Fi), wireless broadband (WiBro), Bluetooth, an infrared (IR) communication, and the like. For example, while transmitting data, the network 121, the network 122, and the network 123 may perform channel coding and spreading of data to be transmitted and then perform radio frequency (RF) processing of the data to thereby transmit the data. If receiving data, the network 121, the network 122, and the network 123 may convert a received RF signal to a baseband signal, and perform de-spreading and channel decoding of the baseband signal to thereby recover data.

The memory 130 may store system data, an application, update history information of the application, user data, and the like, of an operating system (OS) which controls the operation of the portable terminal 100. The user data may include a telephone number, a short message service (SMS) message, a multimedia message service (MMS) message, a compressed image file, a moving picture, and the like.

The characteristic DB 140 may store a characteristic of the application. The characteristic DB 140 may classify the characteristic of the application into various forms and is store the characteristic of the application according to the forms.

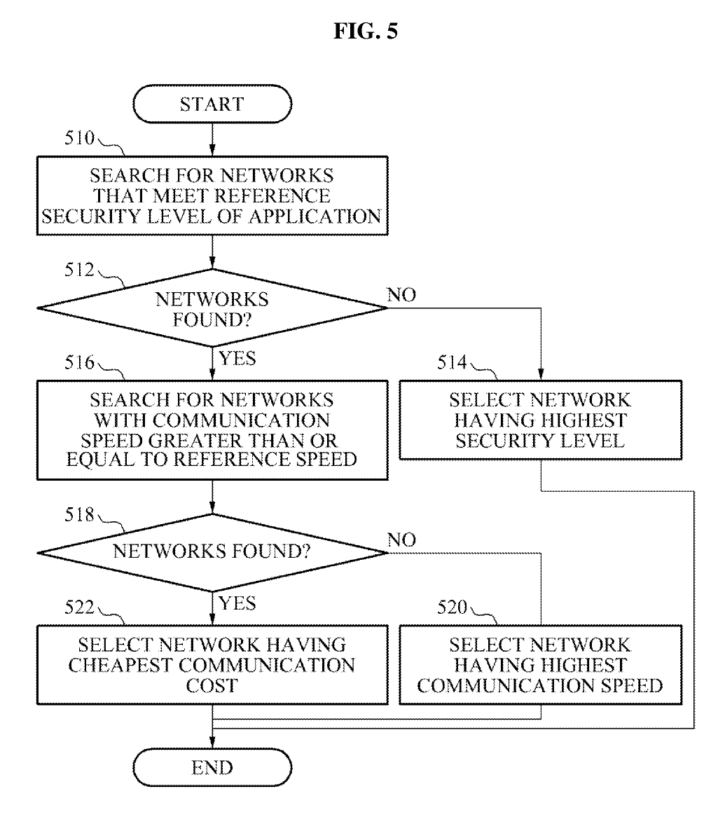

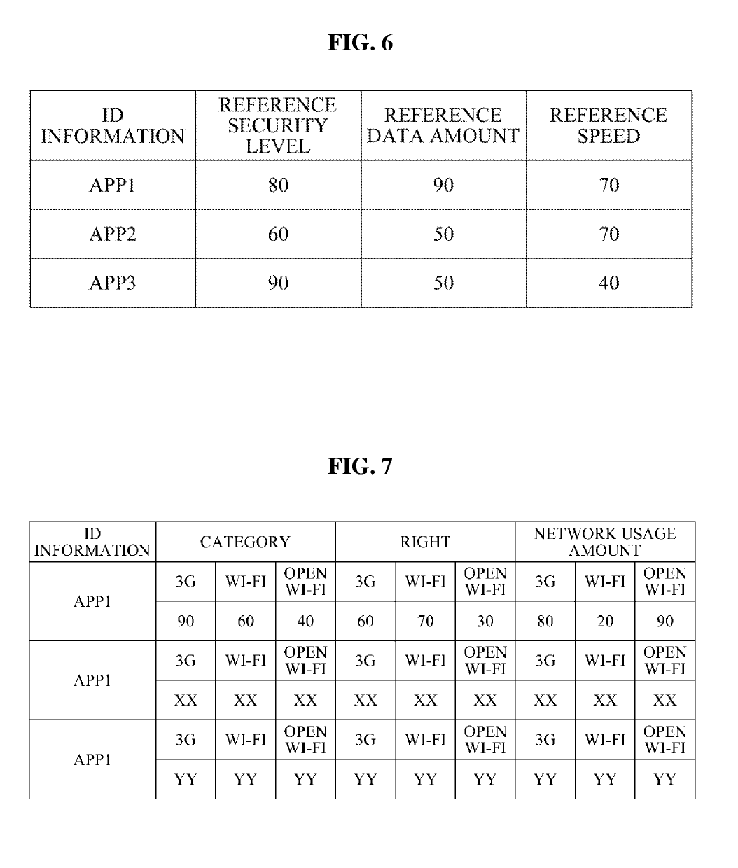

FIG. 6 is a diagram illustrating a characteristic database according to an exemplary embodiment of the present invention. FIG. 7 is a diagram illustrating a characteristic database according to an exemplary embodiment of the present invention. FIG. 6 and FIG. 7 may depict the characteristic DB 140 shown in FIG. 1, though they are not limited as such.

Referring to FIG. 6, the characteristic database may classify a characteristic of an application into a reference security level, a reference data amount or volume, and a reference speed, and may store evaluation scores for each of the reference security level, the reference data amount, and the reference speed. The reference security level may be a minimum security level required to operate the application, the reference data amount may be a minimum amount of data to be transmitted and/or received over a network, and the reference speed may be a network speed required by the application. These “reference” values may also be referred to as “threshold” values.

In FIG. 6, in the reference security level a higher numerical score may indicate an application has a higher security level, in the reference data amount a higher numerical score may indicate an application has a higher reference data amount, and in the reference speed a higher numerical score may indicate an application has a higher reference network speed. However, the present invention is not limited thereto and a higher numerical score in each category may indicate an application has a lower network speed, data amount or volume, or security level.

FIG. 7 is a diagram illustrating a characteristic database according to an exemplary embodiment of the present invention. Referring to FIG. 7, the characteristic database may evaluate scores of a characteristic of an application for each network to which is communication unit 120 may be connected, based on a category of the application, a right of the application, and a network usage amount of the application, and may store the evaluated scores.

If evaluating the characteristic of the application for each network based on the category, the right, and the network usage amount, at least one of a reference security level of the application, a reference data amount of the application, and a reference speed of the application may be used as the reference criterion.

In FIG. 7, numerical scores for each network may indicate the suitability of a corresponding network for the application. Higher numerical scores may indicate that the corresponding network is a suitable network for the application. However, the present invention is not so limited, and a lower numerical score may indicate a greater suitability of a network for the application.

The user pattern database 150 may store an evaluation score of a network. The evaluation score may be determined according to a usage pattern of a user using the network.

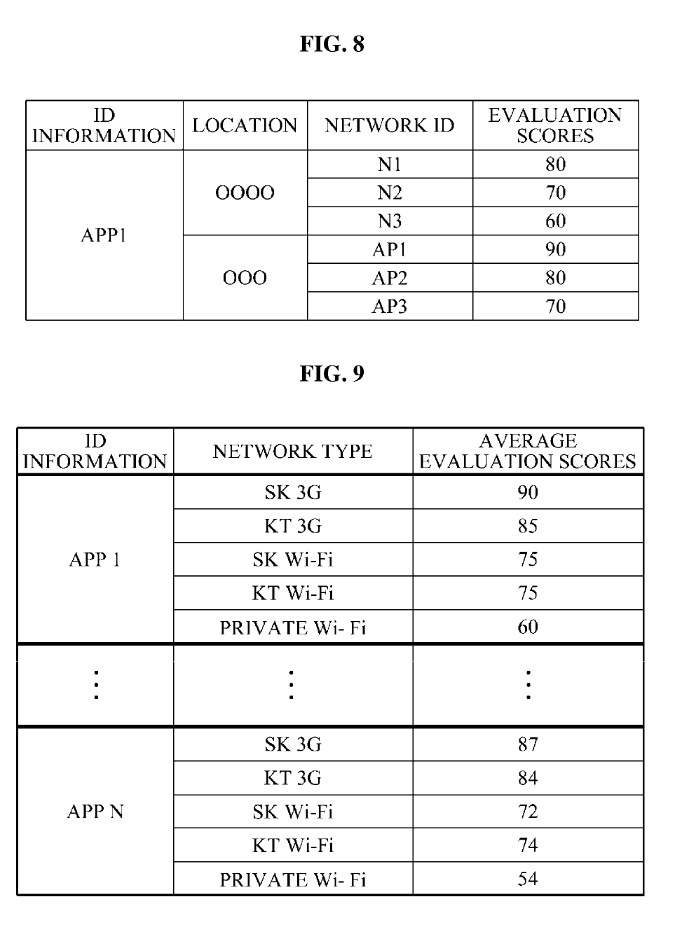

FIG. 8 is a diagram illustrating a user pattern database according to an exemplary embodiment of the present invention. FIG. 8 may depict the user pattern DB 150 shown in FIG. 1, though it is not limited as such. Referring to FIG. 8, the user pattern database may store evaluation scores of multiple networks that are frequently accessed at a reference location or are registered as networks for communication by a user.

Referring back to FIG. 1, the shared characteristic DB 160 may correspond to a database that is generated by collecting characteristics of applications that are determined by a plurality of users. The shared characteristic DB 160 may receive a characteristic of an application through the application characteristic transceiver 115 which may receive the characteristic of an application from a central server, a network, etc., or directly from a portable terminal, etc.

FIG. 9 is a diagram illustrating a shared characteristic database according to an exemplary embodiment of the present invention. FIG. 9 may depict the shared characteristic DB 160 shown in FIG. 1, though it is not limited as such. Referring to FIG. 9, the shared characteristic database may store numerical scores for each network type with respect to each of applications. Numerical scores for each network type may correspond to scores obtained by averaging evaluation scores of users that use a corresponding application, and may correspond to a usage frequency of each network used by the users that use the corresponding application.

Referring to FIG. 9, numerical scores of networks that the application APP1 uses include: SK 3G at a numerical score of 90, KT 3G at a numerical score of 85, SK Wi-Fi at a numerical score of 75, KT Wi-Fi at a numerical score of 75, and private Wi-Fi at a numerical score of 60 scores.

Referring back to FIG. 1, the evaluation basis DB 170 may store reference information that is used to evaluate an application. The reference information may be used to score a characteristic of the application, and may include at least one of a category of the application, a right of the application, a user pattern of the application, and a network usage amount of the application, or a combination thereof.

Examples of the reference information may include reference information in which a reference security level of an application belonging to a reference category is evaluated as 80, reference information in which a reference security level of an application having a reference right is evaluated as 20, and the like. Examples of reference information including at least one combination thereof may include reference information in which if a category is finance, a reference right is access to authentication information, and a network usage amount is may be large, a reference security level is evaluated as 90, a reference data amount is evaluated as 80, and a reference speed is evaluated as 80, and the like. For example, the finance application may be a stock trading application.

The application executor 112 may execute an application if a request for executing the application is received. The application executor 112 may store information about an accessed network in the user pattern database 150, while executing the application.

The application characteristic transceiver 115 may transmit, to a shared server, the characteristic of the application that is stored in the characteristic database 140, and may receive the shared characteristic database 160 from the shared server.

The characteristic determining unit 111 may determine a characteristic of an application based on at least one of a reference security level of the application, a reference data amount of the application, and a reference speed of the application. In response to a request of a user, the characteristic determining unit 111 may receive the characteristic of the application from the user.

The characteristic determining unit 111 may determine the characteristic of the application using a variety of methods.

The characteristic determining unit 111 may evaluate at least one of the reference security level, the reference data amount, and the reference speed of the application based on at least one of identification (ID) information of the application, a category of the application, a right of the application, a user pattern of the application, and a network usage amount of the application.

The characteristic determining unit 111 may compare at least one of the category, the right, the user pattern, and the network usage amount with the reference information, stored is in the evaluation basis DB 170, to thereby evaluate at least one of the reference security level, the reference data amount, and the reference speed of the application.

The characteristic determining unit 111 may determine the characteristic of the application by searching the shared characteristic DB 160 for the application.

If executing the application, the network control unit 113 may select a network to be connected to from among available networks based on the characteristic of the application. The network control unit 113 may select, from among the available networks, a network that satisfies at least one of the reference security level, the reference data amount, and the reference speed of the application, and may connect to and communicate with the selected network.

The network control unit 113 may search for a network that meets a security level, a communication cost, and a communication speed based on a reference priority.

If the reference priority is in an order of: the security level, the communication cost, and the communication speed, the network control unit 113 may initially search for networks that meet the reference security level of the application from among the available networks. The network control unit 113 may then search for networks with a communication cost less than or equal to a reference communication cost based on the reference data amount of the application among the networks determined to meet the reference security level, and may connect to and may communicate with a network having the highest communication speed among the networks determined to meet the security level. For example, the network control unit 113 may operate as shown in FIG. 4.

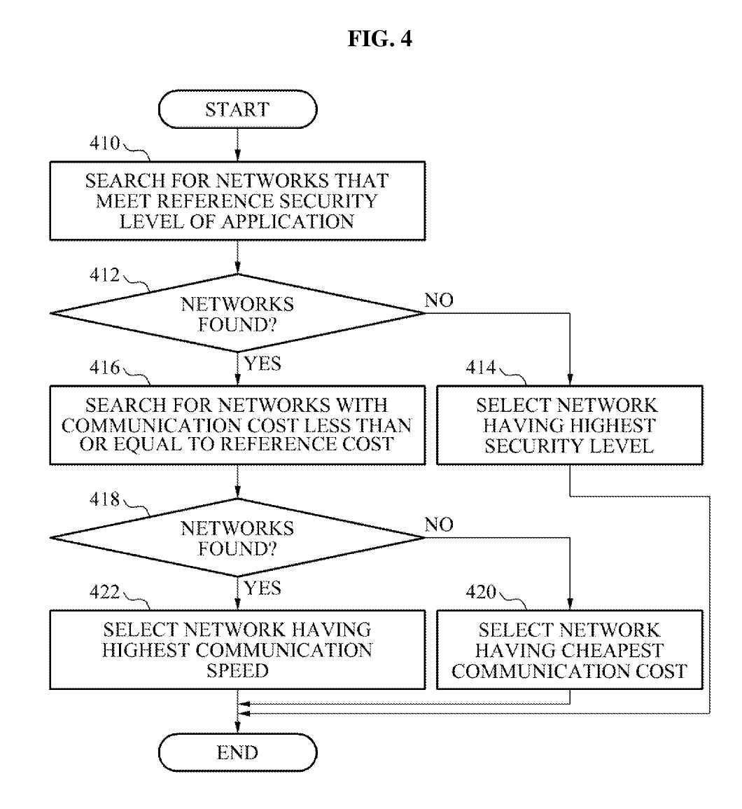

If the reference priority is in an order of the security level, the communication speed, and the communication cost, and if there is no network that satisfies the reference security level of the application in the initial search result, the network control unit 113 may connect to and may communicate with a network having the highest security level among the available networks. For example, the network control unit 113 may operate as shown in FIG. 5.

Referring to the characteristic database of FIG. 7, the characteristic determining unit 111 may score a category of the application for each of the available networks based on at least one of the reference security level, the reference data amount, and the reference speed. The characteristic determining unit 111 may score a right of the application for each of the available networks based on at least one of the reference security level, the reference data amount, and the reference speed. The characteristic determining unit 111 may score a network usage amount of the application for each of the available networks based on at least one of the reference security level, the reference data amount, and the reference speed of the application.

The network control unit 113 may obtain a weighted summation result for each of the available networks and may connect to and may communicate with a network having a largest weighted summation result.

The characteristic determining unit 111 may compare at least one of the category, the right, and the network usage amount of the application with the reference information, and may score the same for each of the available networks.

The network control unit 113 may select, as the network to be connected to, a network having the largest weighted summation score result.

Referring to the characteristic database of FIG. 6, the characteristic determining unit 111 may determine, as the characteristic of the application, a weighted summation result of an evaluation result based on reference priorities of: the reference security level, the reference data amount, and the reference speed of the application.

The network control unit 113 may select a network that includes a value is corresponding to a characteristic of the application from among the available networks having a selection range.

For example, if a 3G network has a selection range between 80 to 100, an un-open Wi-Fi network has a selection range between 60 to 80, and an open Wi-Fi network has a selection range between 50 to 60, and if a weighted summation of an application is 85, the network control unit 113 may select the 3G network to connect to and may communicate with the 3G network.

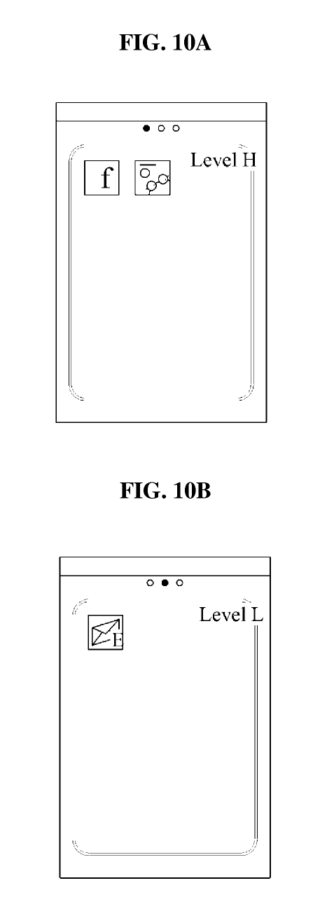

FIG. 10A is a screenshot illustrating classifying and outputting an application according to an exemplary embodiment of the present invention. FIG. 10B is a screenshot illustrating classifying and outputting an application according to an exemplary embodiment of the present invention.

The interface unit 114 may correspond to an apparatus to provide an interface to a user. As shown in FIG. 10A and FIG. 10B, when receiving an input of a user and outputting an application to be displayed, the interface unit 114 may control applications to be classified based on a page unit and/or a folder unit based on a characteristic of each application.

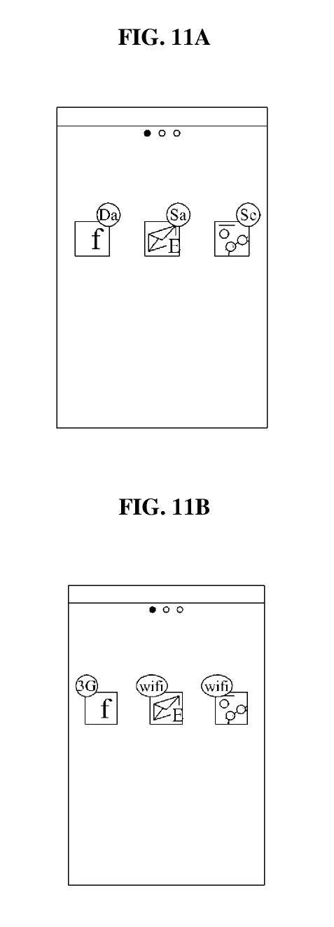

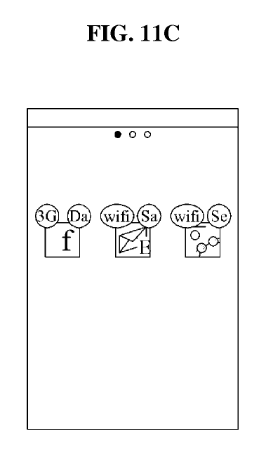

As shown in FIG. 11A, FIG. 11B, and FIG. 11C, when outputting an application, the interface unit 114 may modify the display of an icon corresponding to the application so that the characteristic of the application may be displayed on or with the icon.

The interface unit 114 may classify and display applications according to a security level. Thus, FIG. 10A depicts a page displaying applications having a higher security level and FIG. 10B depicts a page displaying applications having a lower security level.

FIG. 11A is a screenshot illustrating displaying a characteristic of an application on an icon according to an exemplary embodiment of the present invention. FIG. 11B is a screenshot illustrating displaying a characteristic of an application on an icon according to an exemplary embodiment of the present invention. FIG. 11C is a screenshot illustrating displaying a characteristic of an application on an icon according to an exemplary embodiment of the present invention.

As shown in FIG. 11A, the interface unit 114 may display a security icon for classifying applications as dangerous, safe, or secure to be displayed with an icon of an application based on a security level of the application.

As shown in FIG. 11B, the interface unit 114 may display a network icon of a network to be connected to an application with an icon of the application.

As shown in FIG. 11C, the interface unit 114 may display both a security icon and a network icon indicating the security level and a network to be connected to an application with an icon of the application.

The control unit 110 may control the overall operation of the portable terminal 100. The control unit 110 may also perform a portion or all of the operations of the characteristic determining unit 111, the application executor 112, the network control unit 113, the interface unit 114, and the application characteristic transceiver 115. Accordingly, the control unit 110 may include at least one processor configured to perform a portion or all of the operations of each of the characteristic determining unit 111, the application executor 112, the network control unit 113, the interface unit 114, and the application characteristic transceiver 115.

Hereinafter, a method of controlling a network based on a characteristic of an application in a portable terminal will be described with reference to the accompanying drawings.

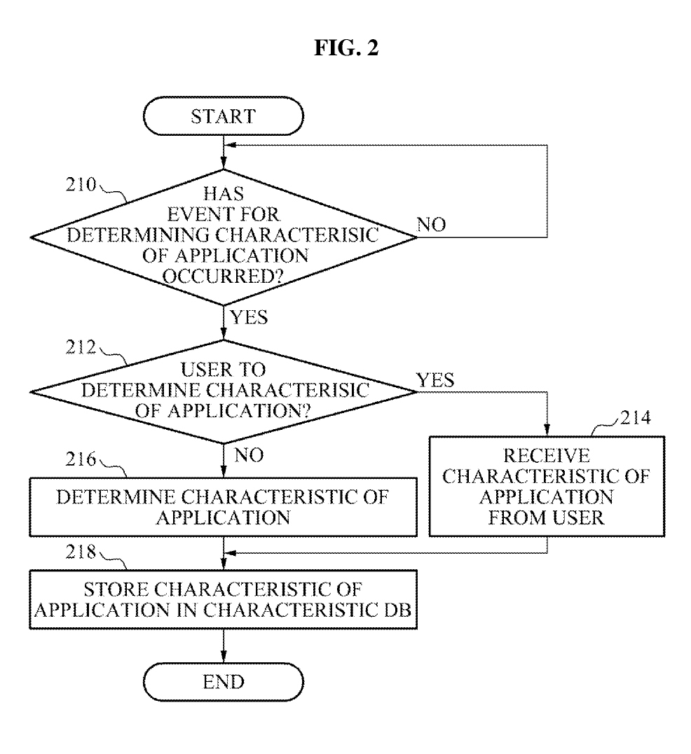

FIG. 2 is a flowchart illustrating a method for determining a characteristic of an application according to an exemplary embodiment of the present invention. The method shown in FIG. 2 will be described as if performed by the portable terminal 100 of FIG. 1, but is not limited as such.

Referring to FIG. 2, in operation 210, the portable terminal may determine whether an event for determining the characteristic of the application has occurred. The event may occur at time intervals that are set by the application, or at a time that a user or a previously or currently connected network sets or requests.

If the event occurred in operation 210, in operation 212 the portable terminal may determine whether the characteristic of the application is to be determined by the user. An entity for determining the characteristic of the application may be established by the application or may be determined from the user using a user interface.

If the user is determining the characteristic of the application in operation 212, in operation 214, the portable terminal may receive the characteristic of the application from the user.

If the user is not determining the characteristic of the application in operation 212, in operation 216, the portable terminal may determine the characteristic of the application based on at least one of the reference security level, the reference data amount, and the reference speed of the application.

In operation 218, the portable terminal may store, in the characteristic database 140, the received or determined characteristic of the application.

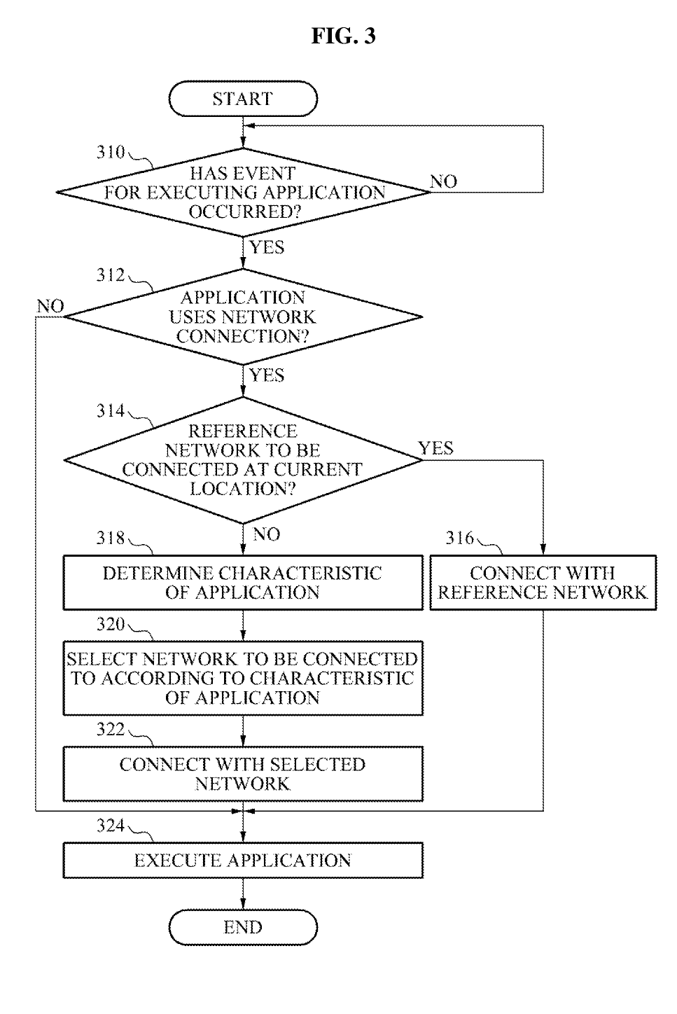

FIG. 3 is a flowchart illustrating a method for connecting to a network according to an exemplary embodiment of the present invention. The method shown in FIG. 3 will be is described as if performed by the portable terminal 100 of FIG. 1, but is not limited as such.

Referring to FIG. 3, in operation 310, it is determined if an event for executing an application is detected. If an event is detected in operation 310, in operation 312, the portable terminal determines whether the application uses a network connection.

If the application does not use a network connection, in operation 324, the portable terminal may execute the application and the method is terminated.

If an application does use a network connection, in operation 314, the portable terminal may determine whether there is a reference network to be connected to at a current location.

If there is a reference network at the current location in operation 314, in operation 316, the portable terminal may be connected to and may communicate with the reference network.

If there is no reference network at the current location in operation 314, in operation 318, the portable terminal may determine the characteristic of the application from a characteristic database.

In operation 320, the portable terminal may select a network to be connected to from among networks available at the current location, based on the characteristic of the application. The portable terminal may select, from the available networks, a network that satisfies at least one of a reference security level of the application, a reference data amount of the application, and a reference speed of the application.

In operation 322, the portable terminal may be connect to and communicate with the selected network. In operation 324, the portable terminal may execute the application.

FIG. 4 is a flowchart illustrating a method for selecting a network to be connected is to according to an exemplary embodiment of the present invention. The method shown in FIG. 4 will be described as if performed by the portable terminal 100 of FIG. 1, but is not limited as such.

Referring to FIG. 4, in operation 410, the portable terminal may search for networks that meet a reference security level of an application among available networks.

In operation 412, the portable terminal may determine whether a network was found that meets the reference security level.

If there is no network that satisfies the reference security level of the application in operation 412, in operation 414, the portable terminal may connect to and may communicate with a network having the highest security level among the available networks.

If there is the network that satisfies the reference security level of the application in operation 412, in operation 416, the portable terminal may search for networks which have a communication cost less than or equal to a reference communication cost based on the reference data amount of the application from among the networks determined in operation 412.

In operation 418, the portable terminal may determine whether there is a network was found with communication costs less than or equal to the reference communication cost.

If networks with communication costs less than or equal to the reference communication cost are not determined in operation 418, in operation 420, the portable terminal may connect to and communicate with a network having the cheapest communication cost from among the networks determined in operation 418.

If the networks with communication costs less than or equal to the reference communication cost are determined in operation 418, in operation 422, the portable terminal may connect to and may communicate with a network having the highest communication speed from is among the networks determined in operation 418.

FIG. 5 is a flowchart illustrating a method for selecting a network to be connected to according to an exemplary embodiment of the present invention. The method shown in FIG. 5 will be described as if performed by the portable terminal 100 of FIG. 1, but is not limited as such.

Referring to FIG. 5, in operation 510, the portable terminal may search for networks that meet a reference security level of the application among available networks.

In operation 512, the portable terminal may determine whether a network was found that meets the reference security level.

If there is no network that satisfies the reference security level of the application in operation 512, in operation 514, the portable terminal may connect to and may communicate with a network having the highest security level among the available networks.

If there is the network that satisfies the reference security level of the application in operation 512, in operation 516, the portable terminal may search for networks which have a communication speed greater than or equal to a reference speed based on a reference data amount of the application among the networks determined in operation 512.

In operation 518, the portable terminal may verify whether there is a secondarily found network.

If networks with communication speeds greater than or equal to a reference speed are not determined in operation 518, in operation 520, the portable terminal may connect to and may communicate with a network having a highest communication speed among the networks determined in operation 518.

If the networks with communication speeds greater than or equal to the reference is speed are determined in operation 518, in operation 522, the portable terminal may connect to and may communicate with a network having the cheapest communication cost from among the networks determined in operation 518.

According to exemplary embodiments of the present invention a portable terminal may determine a characteristic of an application. If the application is executed, the portable terminal may connect the application with a suitable network among available networks based on the characteristic of the application. If an application requesting a high security level is executed, a network priority may be changed based on the security level of the application. If an application requesting a lower security level and a larger network usage amount is executed, the application may be connected to a network having a low communication cost and a high communication speed by matching a network priority based on the communication cost and the communication speed.

The exemplary embodiments according to the present invention may be recorded in a non-transitory computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their is equivalents.

What is claimed is:

1. An apparatus to control access to a network, comprising:
a characteristic determining unit to determine an application characteristic;
a communication unit to determine if networks are available to connect to, and to connect to a first network; and
a network control unit to select the first network according to the application characteristic,
wherein the application characteristic is based on at least one of a reference security level of the application, a reference data volume of the application, and a reference speed of the application.

2. The apparatus of claim 1, further comprising:
an application characteristic transceiver to transmit and receive the application characteristic; and
an application executor to execute the application.

3. The apparatus of claim 1, further comprising:
an interface unit to display an icon with an application icon.

4. The apparatus of claim 3, wherein the icon is a security icon to indicate a security level of the application.

5. The apparatus of claim 3, wherein the icon is a network icon to indicate the first network.

6. The apparatus of claim 1, wherein the network control unit selects the first network according to a reference priority.

7. The apparatus of claim 6, wherein the reference priority is a priority order in which the application characteristics are evaluated.

8. The apparatus of claim 2, further comprising a characteristic database to store application characteristics.

9. The apparatus of claim 2, further comprising a user pattern database to store an evaluation score of the first network, wherein the evaluation score of the first network is determined by the application executor.

10. The apparatus of claim 2, further comprising a shared characteristic database to store application characteristics determined by a second apparatus.

11. The apparatus of claim 2, further comprising an evaluation basis database to store reference information, wherein the reference information is information used to score the application characteristic and the reference information is at least one of a category of the application, a right of the application, a user pattern of the application, and a network usage amount of the application.

12. A method for controlling access to a network, comprising:
determining if networks are available at a location;
determining an application characteristic;
selecting a first network to connect to according to the application characteristic; and
connecting to the first network,
wherein the application characteristic is based on at least one of a reference security level of the application, a reference data volume of the application, and a reference speed of the application.

13. The method of claim 12, wherein determining an application characteristic comprises receiving the application characteristic from a server.

14. The method of claim 12, wherein selecting a first network according to the application characteristic comprises selecting the first network to connect to according to a reference priority.

15. The method of claim 14, wherein the reference priority is a priority order in which the application characteristics are evaluated.

16. The method of claim 13, further comprising storing the application characteristic in a shared characteristic database.

17. The method of claim 14, further comprising determining an evaluation score of the first network and storing the evaluation score in a user pattern database.

18. The apparatus of claim 12, further comprising determining a reference information, wherein the reference information is information used to score an application characteristic and the reference information is at least one of a category of the application, a right of the application, a user pattern of the application, and a network usage amount of the application.

19. The method of claim 12, further comprising:
displaying a security icon with an application icon to indicate a security level of the application.

20. The method of claim 12, further comprising:
displaying a network icon with an application icon to indicate the first network.
